(19) United States
(12) Patent Application Publication
(10) Pub. No.: US 2004/0078439 A1
(43) Pub. Date: Apr. 22, 2004

(54) Messaging method

(76) Inventor: Jens Staack, Kirkkonummi (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/290,451

(22) Filed: Nov. 8, 2002

Related U.S. Application Data
(63) Continuation of application No. PCT/IB02/04317, filed on Oct. 18, 2002.

(51) Int. Cl. G06F 15/16

(52) U.S. Cl. 709/206

(57) ABSTRACT

A messaging method for use in a communications system comprises the steps of sending a message from a system user, the message being intended for a first set of recipients, defining a second set of recipients to which the message is to be sent if it is determined that the message is not to be received by at least one of the recipients of the first set, the first and second set being different and sending a request to prevent delivery of the message to said at least one recipient not to receive the message if it is determined that the message is not to be received by at least one recipient of the first set, and delivering the message only to the recipients of the second set.

This application is a continuation of international application PCT/IB02/04317 filed Oct. 18, 2002 which designated the US and has not yet been published under PCT Article 21(2).

### FIELD OF THE INVENTION

The present invention relates to a messaging method and in particular but not exclusively to a messaging method for use with a multimedia message.

### BACKGROUND TO THE INVENTION

Wireless communication networks are known. One such network 2 is illustrated schematically in FIG. 1. The area covered by the network 2 is divided into cells 4. Each cell 4 is provided with a base station 6. The base stations 6 are arranged to communication with mobile stations or user equipment 8 located in the cells.

Various different communication standards are known or have been proposed. One known standard which is widely used is the GSM (global system for mobile communications) standard. This uses a frequency/time division multiple access technique. The so-called third generation standard is currently being proposed. This third generation standard uses a wide band code division multiple access technique.

The GSM standard primarily was concerned with allowing speech communication. However, the GSM standard has been modified, for example to include the GPRS (general packet radio service) facility which allows data to be more easily transmitted. With both GSM and the currently proposed third generation system, it is desirable to allow multimedia messages to be transmitted between the base station and the mobile station. It should be appreciated that the mobile station can in fact be any suitable user equipment and may for example be a laptop or the like. These multimedia messages can include text, speech, still images, video images or dynamic media.

It is possible that a multimedia message be sent to more than one recipient. There is the problem if the message is sent in error to one of the recipients. It has been proposed that when this occurs, the message is recalled and then resent to the correct recipients. The inventor has realised that this is disadvantageous. Firstly, the message needs to be recalled and then resent to the selected recipients again. This unnecessarily uses up network resources including air interface and network bandwidth.

U.S. Pat. No. 5,481,597 describes how the originator of a message is able to cancel a sent message, that is a message which has been delivered to a recipients mailbox but which has not yet been delivered to the recipient.

### SUMMARY OF THE INVENTION

It is an aim of embodiments of the present invention to address or at least mitigate the above described problems.

According to a first aspect of the present invention there is provided a messaging method for use in a communications system, said method comprising the steps of sending a message from a system user, said message being intended for a first set of recipients, defining a second set of recipients to which the message is to be sent if it is determined that the message is not to be received by at least one of the recipients of the first set, said first and second set being different, and sending a request to prevent delivery of said message to said at least one recipient not to receive said message if it is determined that said message is not to be received by at least one recipient of said first set, and delivering said message only to the recipients of said second set.

According to a second aspect of the present invention there is provided a communications system comprising at least one network, at least one user terminal connected to said at least one network, said at least one user terminal being arranged to send messages, a plurality of recipients connected to said at least one network, wherein said user terminal is arranged to send a message intended for a first set of recipients, the user terminal being arranged to define a second set of recipients to which said message is to be sent if it is determined that said message is not to be delivered to at least one of said recipients of said first set, said first and second sets being different, the user terminal is arranged to send a request to prevent the delivery of said message to at least one recipient, , said system being arranged to deliver said message only to the recipients of said second set..

### BRIEF DESCRIPTION OF DRAWINGS

For a better understanding of the present invention and as to how the same may be carried into effect, reference will now be made by way of example to the accompanying drawings in which:

FIG. 1 shows a schematic representation of a network;

FIG. 2 shows a schematic view of the elements provided for a multimedia service;

FIG. 3 shows a flow chart illustrating the method embodying the present invention; and

FIG. 4 shows a schematic view of the reference architecture for the multimedia service of FIG. 2.

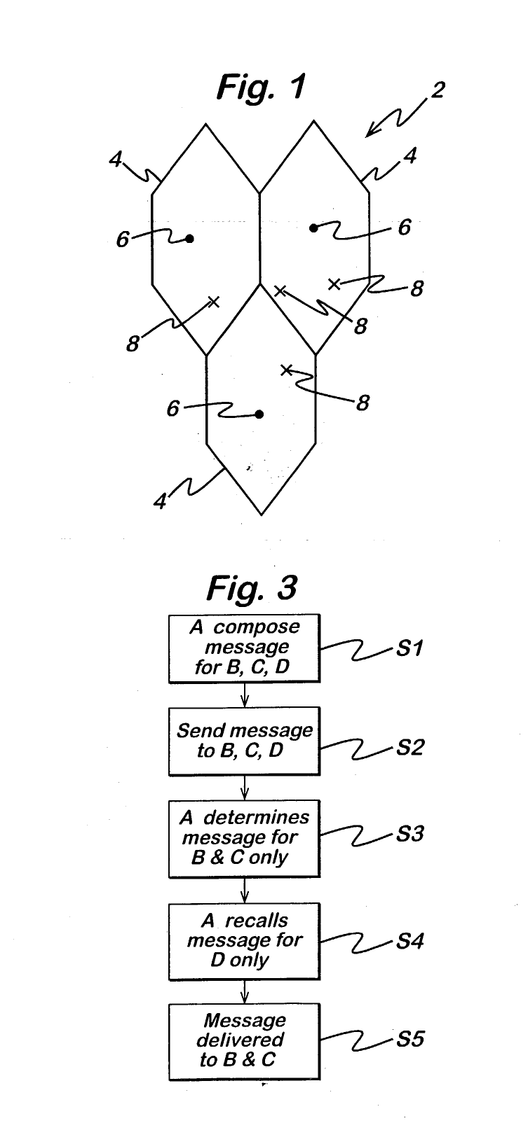

### DETAILED DESCRIPTION OF EMBODIMENTS OF THE PRESENT INVENTION

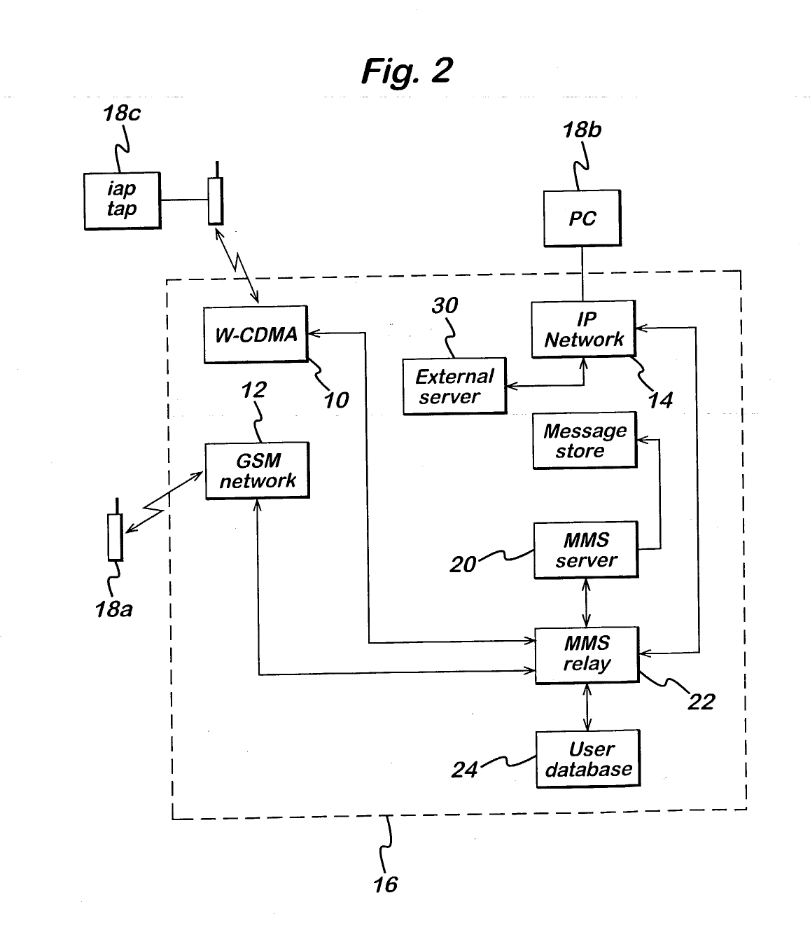

Reference is made to FIG. 2 which illustrates a system having a multimedia messaging facility. The system shown in FIG. 2 comprises a number of different networks. A wide-band code division multiple access (W-CDMA) network 10 is provided. This is the so-called third generation network. The system also comprises a GSM network 12. The GSM network is a so-called second generation network. A third network forms part of the system and is an IP (internet protocol) network 14. It should be appreciated that the system shown in FIG. 2 is an example only and any other different type of network may form part of the system. Embodiments of the present invention can be used with any suitable network such as any suitable broadband radio access network. Additionally, more than one network of the same type may be provided in the system. For example, different operators may operate different networks using the same standard. It should be appreciated that whilst embodiments of the present invention are described in the context of a system which allows multimedia messages to be sent between networks, embodiments of the present invention apply equally to multimedia messaging sent within a network.

The multimedia messaging service architecture is designed to combine different networks and network types and to integrate the messaging system existing within these networks. The area 16 shown in dotted lines represents the multimedia messaging service environment (MMSE). The terminals 18A-C operate with the multimedia messaging service environment 16. The terminals can take any format. For example, terminal 18A is a mobile telephone. Terminal 18B is a PC and terminal 18C is a mobile station connected to a laptop or similar computer. These are just some of the examples of possible terminals. It should be appreciated that other terminals can also be used with embodiments of the present invention. For example, connections may be made using fixed line telephone to computer equipment or the like. The terminals need not be wireless terminals. They may be connected to the respective network via a wired connection or the like.

The MMSE 16 is arranged to provide all of the necessary elements to ensure the delivery, storage and notification of the messages. The elements required to provide the messaging functionality may be located in one of the networks, or may alternatively be distributed across several networks or network types.

As will be appreciated from a consideration of FIG. 2, the different networks 10, 12 and 14 may use the same or different standards and may be provided by the same or different operators. . The networks are connected using the internet protocol and its associated set of messaging protocols. This allows messages in, for example, the GSM network 12 and the W-CDMA network 10 to be compatible with the messaging systems found on the internet.

The various messaging elements of the MMSE 16 will now be described. It should be appreciated that the MMSE network elements are under the control of a single administrator. Where a user is roaming, the visited network is considered as part of the user's multimedia messaging service environment. However, subscribers to another service provider are considered to be part of a separate multimedia service environment.

A multimedia server 20 and a multimedia relay 22 are provided. These entities are responsible for the storage and handling of incoming and outgoing messages. These entities are also responsible for the transfer of messages between different messaging systems. In the embodiment shown in FIG. 2, the server 20 and the relay 22 are shown as different entities. In alternative embodiments of the present invention, these elements may be provided by a single entity. Alternatively, in other embodiments of the present invention, the functionality associated with this server 20 and the relay 22 may be distributed. Effectively, the server and relay receive messages and then cause those messages to be delivered.

A user database 24 is provided. The user database contains user related information such as subscription information and configuration information. This can include user profiles and the home location register. In the embodiment shown in FIG. 2, the user database is shown as a single entity. However, in alternative embodiments of the present invention, more than one entity may be provided in order to provide the user database function.

A MMS user agent is provided. This is provided on the mobile station and/or an external device which is connected to the mobile station. It may also be provided on for example a PC. This effectively is software and provides an application layer function that allows the users to view, compose and handle the multimedia messages. More particularly, this functionality allows the users to submit, receive and delete messages. The user agent, that is the user agent software, allows the user equipment, for example the terminals 18A-C or the like to communicate with the relay and server 20 and 22. The relay and server in turn may communicate with an external server based on internet protocols or via any other suitable protocols.

The relay and server 20 and 22 can allow functionality between the external services and the user to converge. This means that embodiments of the present invention can be used with different server types across different networks.

Reference is made to FIG. 4 which shows in more detail the multimedia messaging reference architecture and in particular the different interfaces. Reference point MM1 is used to submit multimedia messages from the user agent 32 to the relay/server 20/22. This reference allows the user agent to pull multimedia messages from the relay/server, allows the relay/server to push multimedia messages to the user agent and allows the exchange of notifications of delivery reports between the server/relay and the user agent.

MM2 provides the communication between the relay 22 and the server 20.

MM3 is used by the relay/server 20/22 to send multimedia messages to and retrieve multimedia messages from servers of external messaging systems that are connected to the service provider's multimedia message relay/server. The external server 30 may be an email server, a fax server or the like. A number of different external servers may be provided.

Reference point MM4 allows multimedia relay/servers from different systems/networks or environments to transfer messages between them. The relay/server 36 of the different environment can communicate with user agents, for example, user agent B, which is referenced 38.

Reference point MM5 allows information to be provided to the relay server from the home location register 40. This allows information about the user to be passed to the relay/server.

Reference point MM6 allows communication between the relay/server and the user database 24.

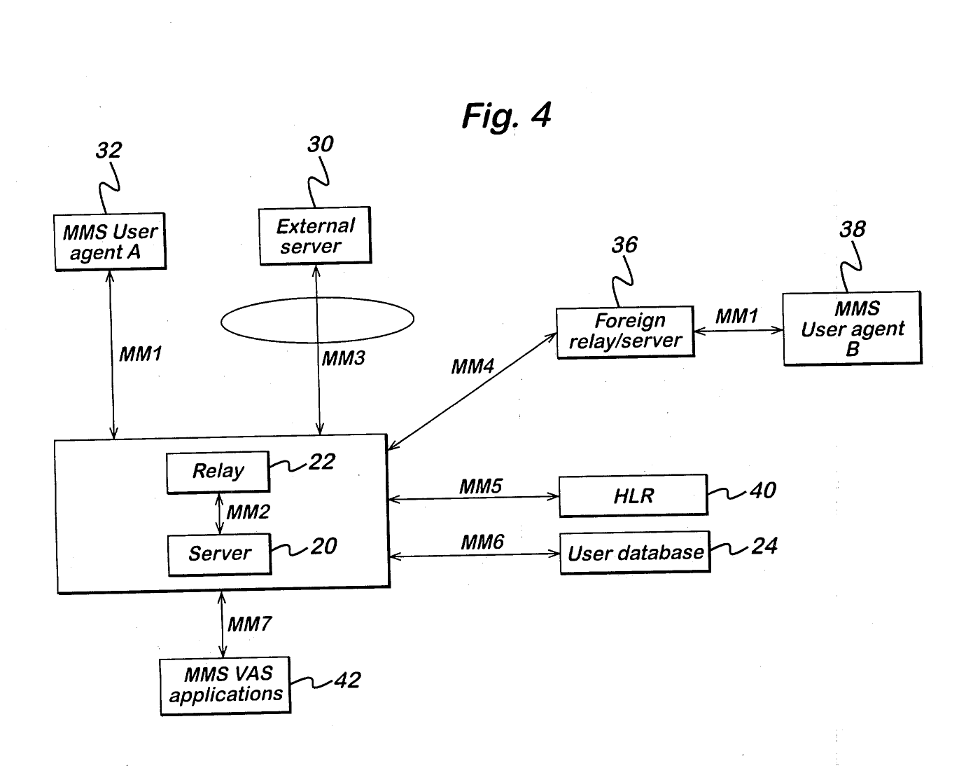

Reference point MM7 is used to transfer multimedia messages from the relay/server to the value added service application 42 and to transfer multimedia messages from the value added service application 42 to the relay/server. In the context of embodiments of the present invention, the term recalling refers to the situation where the multimedia message originator requests that the network stop selectively the delivery of a message which has already been sent to the network for delivery to at least two recipients. In preferred embodiments of the present invention, the recall of a message means that the message is not delivered to those recipients for whom the message has been recalled but the message is still delivered to those users for whom the message has not been recalled. This is described in more detail with reference to FIG. 3, which shows a flow diagram of a method embodying the present invention.

A first user A composes a message which is intended for recipients B, C and D. This takes place in step S1.

In step S2, the message is sent to recipients B, C and D. However, in step S3, A determines that the message should only have been sent to recipients B and C and not recipient D. Accordingly, in step S4, the message for user D is recalled. The message is not recalled from users B and C and is delivered as normal.

In step S5, the message is delivered to recipients B and C. It should be appreciated that in practice, steps S4 and S5 may be carried out at more or less the same time. However, this will depend on the implementation of embodiments of the present invention.

The method described in relation to FIG. 3 thus allows a multimedia server's message to be recalled selectively. Unlike the previously proposed solution, it is not necessary to recall the message from all of the users. As the message is not recalled from all of the recipients and sent to the required recipients again, interface bandwidth and network bandwidth can be saved. In one modification to the embodiment described, the message is initially intended for a first set of users. The message can be recalled for any one or more of the intended recipients. The user can at this stage specify additional recipients. Thus the message is delivered to the original recipients for which the message has been recalled as well as the newly specified recipients. This can be achieved by any suitable method. For example a message could be sent from the mobile station or the like via a SMS message or by any other suitable method. Thus, the message can be recalled and sent to a subset of the first set (that is only to some of the users of the first set) or to one or more of the original recipients and one or more further recipients not included in the first set. The new set, that is the second set of recipients for a message is defined by the user in preferred embodiments of the invention, It should be appreciated that the defining of the second set includes separately defining a second set or defining a modification of the first set.

Whilst embodiments of the present invention have been described in the context of a multimedia messaging service, it should be appreciated that embodiments of the present invention can be used with any other type of messaging service. For example, embodiments of the present invention could be used with a normal email service.

Embodiments of the present invention are particularly applicable to the third generation multimedia messaging service which is described in the document “3GPPTS23.140—Technical Specification—Third Generation Partnership Products; Technical Specification Group Terminal; Multimedia Messaging Server; Functional Description”.. This document is herein incorporated by reference.

The various elements of the MMS elements will now be described in more detail. The MMS user agent allows the presentation of multimedia messages and the presentation of notifications to the user. Additionally, the user agent shall allow the multimedia messages to be delivered to that user. In preferred embodiments of the present invention, the user agent is able to allow multimedia messages to be composed and submitted. The user agent may also allow the signing of a multimedia message on an end user to end user basis. Decryption and encryption of a multimedia message on an end user to an end user basis may also be provided. The user agent may allow the multimedia messages to be stored on the terminal or the like. The user agent may also allow the handling of external devices and user profile management. This is by way of example and other functionalities may be provided by the user agent.

The multimedia message may comprise one or more of the following types of message; a text message such as plain text or an SMS (short message service) message; speech; still image; data; sound, video; and file format for dynamic media.

The multimedia service relay and server 20 and 22 is, as described previously, responsible for the storage and handling of messages. The relay and server 20 and 22 are arranged to receive and send messages. They are also able to enable and disable the function. The multimedia servers can be personalised depending on the user profile information. They can also delete multimedia messages depending on the user profile or filtering information. The relay and server may be able to carry out media format conversion and/or media type conversion. The messages received at the relay and server can be converted to multimedia messaging format. For example, a fax can be converted to multimedia format. Likewise, the relay and server can convert multimedia messages into a different format, for example, an internet email format. The relay and server can retrieve message content and forward messages. Additionally, multimedia messages can be screened. The relay and server can negotiate terminal capability. The relay and server can notify the multimedia message to the user agent as well as generating call data records. Address translation and address hiding are other functionalities provided by the relay and server. The message properties on the server for example, a voice mail or email server, can be managed. The relay and server can also provide temporary and/or persistent storage of messages. The relay and server can ensure that messages are not lost until they have been successfully delivered.

External servers 30 can be provided within or connected to the multimedia servers environment. These external servers may be email servers, SMS servers, fax servers or the like. The MMS relay and server effectively allows communication between the external servers 30 and the multimedia server's user agent.

The user data base 24 provides multimedia user subscription information as well as information for the control of access to the multimedia servers. Additionally, the user database can store information for the control of the extent of available server capability. The user database may also comprise a set of rules for the handling of incoming message and their delivery. Finally, the database may also include information on the current capabilities of the user terminals.

The method described in relation to FIG. 3 will now be described in more detail. Consider user 18A. When a user intends to send a multimedia message to two or more users, the multimedia message provided by the user 18A is submitted to the server 20 and relay 22 via the GSM network 12. The user 18A indicates the addresses of the multimedia message recipients and the MIME content type of the message. Optionally, the user 18A may specify one or more of the following:

1. Request a delivery report for the message.

2. Request a read reply report for the message.

3. Provide a time stamp for the time of submission of the message.

4. Set the earliest desired time of delivery for the message.

5. Set the desired time of expiry for the message.

6. Indicate the address from which the message is sent.

7. Set further message qualifications such as priority, message class and type.

8. Request the address of the sender 18A to be hidden from the recipients.

When the relay and server 20 and 22 receives the multimedia message from the user 18A, the relay and server 20 and 22 assign a message identification to the multimedia user and provides the sender with this message identification. The server and relay retain the multimedia message until the earlier desired time of delivery, if this optional feature has been selected. If this feature is not supported or selected, then the multimedia message is immediately routed forward.

The server and relay may provide a time stamp. This may override the sender's time stamp.

The relay and server inserts the address of the originating user 18A into the multimedia message if it has not already been included. The sender's address may be sent to the recipient, depending on whether or not the user allows the address to be identified to the recipient. The server and relay is responsible for resolving the recipient's address and for the routing of the multimedia message to the recipients. If a delivery report or read reply report is requested, then this indication is forwarded to the recipient along with the message. The relay and server also pass the indication about the MIME content of the message and message qualifications to the recipient.

If the user subsequently wishes to recall the message so that it is not delivered to one of the users, the user will forward a message to the relay and server. This message may be a “recall command” message to the relay/server to recall the particular message to the particular recipient.

This recall message may take a number of different forms:

1) A special recall command message may be provided with the same message identity (ID) as the original, and include the recipients address and the addresses of the recalled recipients. The message would include a field for the recalled recipients.

2) A special recall command message may be provided with the same message ID and only the addresses of the recalled recipients. The message would include a field for the recalled recipients

3) An “empty” or “special recall” message may be sent with the same message ID and the correct recipients. The addresses of the recipients for which the message is to be recalled are left out. The relay/server is arranged to make a address comparison to determine for which of the recipients the message has been recalled.

4) The original multimedia message (with all of its content) is resent with the same message ID and the correct recipients (leaving out the addresses of the recipients for whom the message has been recalled. The relay/server needs then to make a address comparison to determine for which of the recipients the message has been recalled.

If the relay and server has not yet forwarded the message to the recipients, the relay and server will ensure that the message is only delivered to those users for which the message has not been recalled. If the relay and server has already sent the message for delivery to an other network (e.g. an other relay/server by using the MM4 interface), the relay and server may forward a recall message to the respective network element to prevent the message being delivered to a particular user.

If the message has been already delivered to a recipient for which the message is recalled, the relay/server recalls the message from the user agent UA. It is then up to the user agent UA implementation to delete the recalled message (which might be already read).

The relay and server may generate a notification which is sent to the recipients indicating that a message is in the relay or server. The recipient on receiving the notification may subsequently retrieve that message from the relay and server. In alternative embodiments of the present invention, the message may automatically be delivered by the server and relay to the recipients, as long as no recall is received. Depending on the requests of the sender and/or the user profile, the address and/or identify of the sender may be hidden from the recipient. If a delivery report has been requested, a delivery report may be generated by the relay and server when the message has been delivered to the recipient. A read reply report may alternatively or additionally be generated.

1. A messaging method for use in a communications system, said method comprising the steps of:
sending a message from a system user, said message being intended for a first set of recipients;
defining a second set of recipients to which the message is to be sent if it is determined that the message is not to be received by at least one of the recipients of the first set, said first and second set being different; sending a request to prevent delivery of said message to said at least one recipient not to receive said message if it is determined that said message is not to be received by at least one recipient of said first set; and
delivering said message only to the recipients of said second set.

2. A method as claimed in claim 1, wherein said message comprises a multimedia service message.

3. A method as claimed in claim 1, wherein said second set is a subset of said first set.

4. A method as claimed in claim 1, wherein said second set includes recipients not included in said first set.

5. A method as claimed in claim 1, wherein said message includes one or more of the following:
text; speech; still image; data; sound; and video.

6. A method as claimed in claim 1, comprising the step of composing said message to be sent to said first set of recipients.

7. A method as claimed in claim 1, comprising the step of sending said message from said system user to a first entity, and a step of transferring said message from said first entity to at least one recipient.

8. A method as claimed in claim 7, comprising the step of the first entity transferring to at least one recipient notification of said message.

9. A method as claimed in claim 8, comprising a step of at least one recipient retrieving said message from said entity after receipt of said notification.

10. A method as claimed in claim 7, wherein said first entity provides a server and/or relay function.

11. A method as claimed in claim 7, , comprising the first entity receiving information from a user identifying which of said recipients should not receive said message.

12. A method of claim 11, comprising the first entity preventing the message being transferred to a recipient for which said message is not intended.

13. A method as claimed in claim 1, comprising the step of the user including an identity of the user in said message.

14. A method as claimed in claim 1, comprising the step of the user including an identity of a plurality of recipients in said message.

15. A method as claimed in claim 1, wherein said communications system comprises at least one network.

16. A method as claimed in claim 15, wherein at least one of network comprises a wireless communications network.

17. A method as claimed in claim 16, wherein said wireless communication network is one of the following types of network:
Code division multiple access network; broadband radio access network and GSM network.

18. A method as claimed in claim 15, wherein said at least one network comprises a wired communications network.

19. A method as claimed in claim 18, wherein at least one network comprises an IP network.

20. A method as claimed in claim 1, wherein said request comprises a recall message.

21. A method as claimed in claim 20, wherein said recall message identifies the at least one recipient not to receive said message.

22. A method as claimed in claim 20, wherein said recall message omits information identifying the at least one recipient not to receive said message, said recipients which are not to receive said message being identified by comparing the information on the first set of recipients with information contained in said recall message.

23. A method as claimed in claim 20 , wherein said recall message identifies each of the first set of recipients.

24. A method as claimed in claim 20, wherein said recall message does not include the original message.

25. A communications system comprising:
at least one network;
at least one user terminal connected to said at least one network, said at least one user terminal being arranged to send messages;
a plurality of recipients connected to said at least one network, wherein said user terminal is arranged to send a message intended for a first set of recipients, the user terminal being arranged to define a second set of recipients to which said message is to be sent if it is determined that said message is not to be delivered to at least one of said recipients of said first set, said first and second sets being different, the user terminal is arranged to send a request to prevent the delivery of said message to at least one recipient, said system being arranged to deliver said message only to the recipients of said second set.

26. A system as claimed in claim 25, wherein a first entity is provided, said first entity being arranged to receive said message from said user, said message being transferred to at least one recipient from a first entity.

27. A system as claimed in claim 26, wherein said first entity provides a server and/or relay function.
